(19) United States
(12) Patent Application Publication
(10) Pub. No.: US 2026/0321157 A1
(43) Pub. Date: Oct. 15, 2026

(54) SYSTEM AND METHOD FOR CONTROLLING A VEHICLE FOR LEARNING ADVANCED DRIVING SKILLS

(71) Applicant: Toyota Research Institute, Inc., Los Altos, CA (US)

(72) Inventors: James Andrew Dallas, Mountain View, CA (US); Allison Marie Morgan, Oakland, CA (US); Hiroshi Yasuda, San Carlos, CA (US); Michael Thompson, San Juan Capistrano, CA (US); Tiffany L Chen, San Jose, CA (US); John K Subosits, Menlo Park, CA (US)

(73) Assignees: Toyota Research Institute, Inc., Los Altos, CA (US); Toyota Jidosha Kabushiki Kaisha, Toyota-shi Aichi-ken (JP)

(21) Appl. No.: 19/176,805

(22) Filed: Apr. 11, 2025

(51) Int. Cl. G09B 19/16; B60K 31/00; B62D 15/02

(52) U.S. Cl. CPC G09B 19/167

(57) ABSTRACT

Systems and methods for controlling a vehicle are described, so as to train a driver to perform a driving maneuver. In one example, a system utilizes a non-linear model predictive control to generate control inputs for a first actuator to achieve the driving maneuver by the vehicle while a driver simultaneously provides driver inputs to a second actuator.

### TECHNICAL FIELD

The subject matter described herein relates, in general, to systems and methods for controlling a vehicle for learning advanced driving skills.

### BACKGROUND

The background description provided is to present the context of the disclosure generally. Work of the inventor, to the extent it may be described in this background section, and aspects of the description that may not otherwise qualify as prior art at the time of filing, are neither expressly nor impliedly admitted as prior art against the present technology.

Advanced driving skills may be required to perform difficult vehicle maneuvers. One particular vehicle maneuver, drifting, requires delicately balancing steering and throttle inputs to keep a vehicle sliding without losing control. Drifting starts by bringing the vehicle up to the friction limits, at which excessive throttle can be applied to break traction at the rear tires. The vehicle then builds sideslip and starts sliding. Once traction is broken, the driver must “catch” the drift by releasing the throttle and applying counter steer. Then, once the drift is caught, the driver must begin to apply the throttle and delicately balance the throttle and steering application to maintain the drift. This requires correct timing and input adjustments to keep the vehicle from recovering traction and from spinning out.

Learning these advanced driving skills is fairly difficult and requires significant trial and error. Further still, learning these skills can be potentially dangerous, as an unskilled driver may cause the vehicle to spin out or otherwise move in an uncontrolled manner.

### SUMMARY

This section generally summarizes the disclosure and is not a comprehensive explanation of its full scope or all its features.

In one embodiment, a system includes a memory in communication with a processor. The memory includes instructions that, when executed by the processor, cause the processor to control a first actuator by a vehicle control system that uses a non-linear model predictive control (“NMPC”) to generate control inputs for the first actuator to achieve a driving maneuver by the vehicle while a driver simultaneously provides driver inputs to a second actuator.

In another embodiment, a method includes the step of controlling a first actuator by a vehicle control system that uses an NMPC to generate control inputs for the first actuator to achieve a driving maneuver by the vehicle while a driver simultaneously provides driver inputs to a second actuator.

In yet another embodiment, a non-transitory computer-readable medium has instructions that, when executed by a processor, cause the processor to control a first actuator by a vehicle control system mounted within a vehicle that uses an NMPC to generate control inputs for the first actuator to achieve a driving maneuver by the vehicle while a driver simultaneously provides driver inputs to a second actuator.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements, or multiple elements may be designed as one element. In some embodiments, an element shown as an internal component of another element may be implemented as an external component and vice versa. Furthermore, elements may not be drawn to scale.

FIG. 1 illustrates a vehicle at different time steps performing a drifting maneuver.

FIG. 2 illustrates one example of using the system and method for controlling a vehicle to learn advanced driving skills to train a driver.

FIG. 3 illustrates a rear wheel drive model for a vehicle performing a drifting maneuver.

FIG. 4 illustrates a vehicle incorporating a vehicle control system for controlling a vehicle such that a driver can learn advanced driving skills.

FIG. 5 illustrates a more detailed view of the vehicle control system of FIG. 4.

FIG. 6 illustrates a method for training a driver to perform an advanced vehicle maneuver using the vehicle control system of FIG. 4.

### DETAILED DESCRIPTION

Described herein are systems and methods for training a driver to perform an advanced driving maneuver, such as a drifting maneuver. As mentioned in the background section, drifting is a driving maneuver where the driver intentionally oversteers, causing the rear wheels to lose traction while maintaining control through a corner. This occurs when the driver uses a combination of longitudinal inputs (i.e., throttle, brakes) and lateral inputs (i.e., steering) to keep the vehicle in a controlled slide. As such, drifting requires precise application of both throttle and steering by the driver in order to perform and maintain the drifting maneuver. Developing these skills is time-consuming and could be dangerous, especially if the vehicle spins out of control while the driver attempts to practice this maneuver.

The systems and methods described herein essentially perform task decomposition to teach advanced driving maneuvers, such as drifting. Moreover, in one example, a system mounted within the vehicle allows shared control of the vehicle, such that a vehicle control system and/or a driver can provide inputs to one or more actuators, such as actuators that control the throttle, steering, brakes, etc. In order to train the driver to perform the maneuver, the vehicle control system may control one set of actuators while the driver is allowed to control another set of actuators. Moreover, the vehicle control system may utilize an NMPC algorithm to generate the appropriate inputs to control one set of actuators to achieve the driving maneuver while the driver provides inputs to another set of actuators.

In some cases, the actuators controlled by the driver or inputs generated utilizing the NMPC algorithm can be broken into two groups: actuators that control the longitudinal movement of the vehicle (such as throttle and/or brakes) and actuators that control the lateral movement of the vehicle (such as steering). As such, the driver only needs to focus on mastering controlling one set of actuators (i.e., longitudinal-related actuators or lateral-related actuators), while the vehicle control system controls the other set of actuators. Thereafter, the actuators previously controlled by the driver can then be controlled by the vehicle control system, while the actuators previously controlled by the vehicle control system using the NMPC algorithm can be controlled by the driver, allowing the driver to master controlling one set of actuators and then another. It has been observed that this type of training results in faster learning of a driving maneuver, such as drifting.

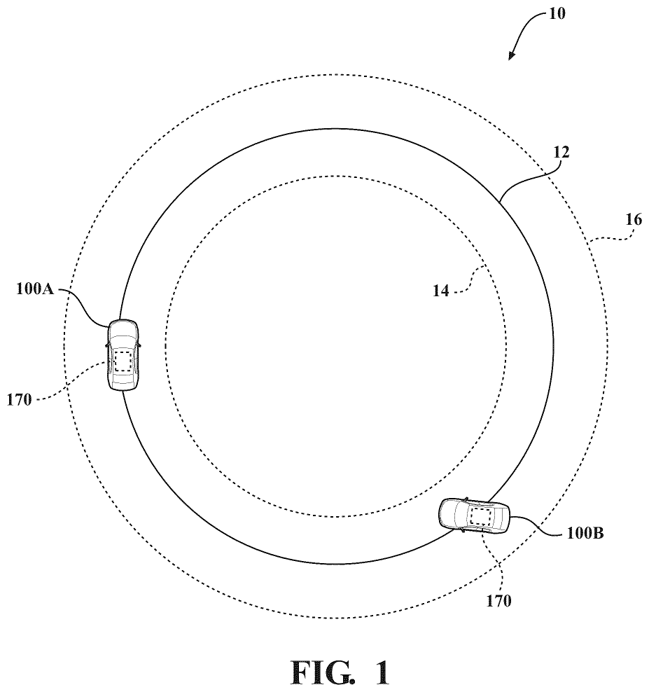

Moreover, referring to FIG. 1, illustrated is a track 10 that includes a line 12, generally in the shape of a circle. Here, when learning drifting, a driver of the vehicle should generally guide the vehicle along the line 12 so that the vehicle stays within the track edges 14 and 16. In addition, the driver should cause the vehicle to oversteer such that the rear wheels of the vehicle lose traction, but the driver remains in control of the vehicle such that the vehicle stays within the track edges 14 and 16.

Also illustrated in FIG. 1 is the vehicle 100A-100B at different time steps, when the vehicle is shown at a first time step as vehicle 100A and at a later time step as vehicle 100B. As will be explained in greater detail later, the vehicle 100A-100B includes a vehicle control system 170 that is capable of allowing shared control of the actuators of the vehicle that control one or more vehicle systems, such as the longitudinal control systems (throttle, brake, etc.) and the lateral control systems (steering, etc.). Here, the vehicle control system 170 utilizes an NMPC algorithm to generate control inputs for one set of actuators while the driver controls another set of actuators so that the driver can first master controlling one set of actuators before moving onto another set of actuators controlled by the vehicle control system 170.

As such, in this example, at the first time step, the vehicle 100A is in a stopped position. Here, as an example, the vehicle control system 170 could control the longitudinal movement of the vehicle 100A, and the driver can control the lateral movement of the vehicle 100A. The vehicle control system 170 would adjust the throttle of the vehicle 100A while the driver adjusts the steering to follow along the line 12. The vehicle control system 170 controls the throttle of the vehicle 100A to cause the vehicle to perform a drifting maneuver, as shown as the vehicle 100B. By allowing the vehicle control system 170 to control the throttle, the driver can focus on controlling the steering to achieve the drifting maneuver. Thereafter, the driver may be in control of the throttle, while the vehicle control system 170 is in control of the steering, allowing the driver to focus on controlling the throttle to achieve the drifting maneuver.

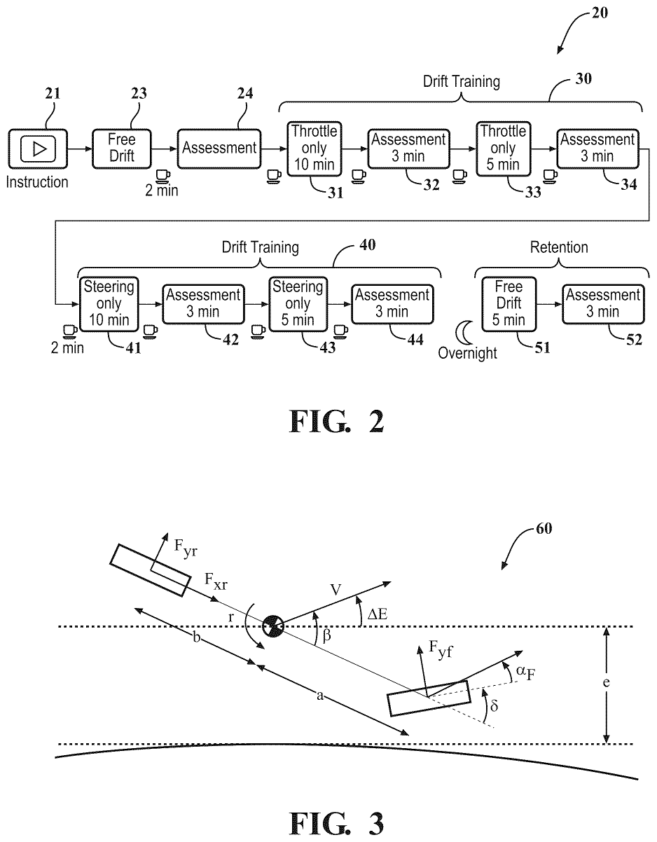

FIG. 2 illustrates a timeline 20 of how driver training utilizing the vehicle control system 170 mounted within the vehicle 100 could be performed. Moreover, at time 21, the driver could be provided with an instructional video illustrating how to perform a particular vehicle maneuver, in this case, drifting. At time 23, the driver could be allowed to utilize the vehicle 100 to attempt to perform drifting without any assistance from the vehicle control system 170. At time 24, an assessment could be performed to determine how well the driver did when attempting the maneuver without any assistance from the vehicle control system 170.

Times 31-34 involve drift training 30 wherein the vehicle control system 170 controls the steering of the vehicle 100 (lateral movement), while the driver controls the throttle of the vehicle 100 (longitudinal movement). Specifically, at time 31, the driver controls the throttle of the vehicle 100 while the vehicle control system 170 controls the steering. At time 32, an assessment is performed. At time 33, the driver again is allowed to control the throttle of the vehicle 100 while the vehicle control system controls the steering, followed by an assessment time 34.

Times 41-44 involve drift training 40 wherein the vehicle control system 170 controls the throttle of the vehicle 100, while the driver controls the steering of the vehicle 100. Specifically, at time 41, the driver controls the steering of the vehicle 100 while the vehicle control system 170 controls the throttle. At time 42, an assessment is performed. At time 43, the driver again is allowed to control the steering of the vehicle 100 while the vehicle control system controls the throttle, followed by an assessment time 44.

Thereafter, at time 51, the driver may be provided with free drift time to attempt to perform drifting without the assistance of the vehicle control system 170. This may be followed by an assessment, as shown at time 52. It has been observed that by enabling the driver to concentrate on mastering a single set of actuators, such as steering or throttle, while the vehicle control system 170 manages the other set, the driver can more rapidly acquire proficiency in the maneuver.

As mentioned before, the vehicle control system 170 utilizes an NMPC algorithm. In one example, a single track model is utilized, as this has been shown to be suitable fidelity for autonomous drifting. Moreover, FIG. 3 illustrates a vehicle model 60 that may be utilized by the vehicle control system 170. Moreover, the vehicle states of the vehicle 100 are given by the following:

$$x = [ \begin{matrix}r \\ V \\ β \\ {ω}_{r} \\ e \\ Δ ϕ \\ δ \\ τ\end{matrix} ] = [ \begin{matrix}Yaw rate \\ Velocity \\ Sideslip \\ Rear wheel speed \\ Lateral error \\ Course error \\ Roadwheel angle \\ Engine torque\end{matrix} ] . \qquad ( 1 )$$

The state dynamics are as thus:

$$\dot{x} = [ \begin{matrix}\frac{{aF}_{yf} cos δ + {aF}_{xf} sin δ - {bF}_{yr}}{{I}_{z}} \\ \frac{- {F}_{yf} sin ( δ - β ) + {F}_{xf} cos ( δ - β ) + {F}_{yr} sin β + {F}_{xr} cos β}{m} \\ \frac{{F}_{yf} cos ( δ - β ) + {F}_{xf} sin ( δ - β ) + {F}_{yr} cos β - {F}_{xr} sin β}{mV} - r \\ \frac{{r}_{w} ( G τ - {F}_{xr} {r}_{w} )}{{I}_{w}} \\ V sin ( Δ ϕ ) \\ \dot{ϕ} - {κ}_{ref} \frac{V cos ( Δ ϕ )}{1 - {κ}_{ref}} \\ \dot{δ} \\ \dot{τ}\end{matrix} ] \qquad ( 2 )$$

where the course rate is

\dot{φ}=\dot{β}+r. (3)

The inputs are as follows:

$$u = [ \begin{matrix}\dot{δ} \\ \dot{τ}\end{matrix} ] = [ \begin{matrix}Roadwheel angle rate \\ Engine torque rate\end{matrix} ] \qquad ( 4 )$$

where a and b represent the distance from the center of mass to the front and rear axle, respectively, I_{z} is the yaw moment of inertia, m is the vehicle mass, r_{w} is the tire radius, G is the engine to wheel torque ratio, I_{w} is the rear axle moment of inertia, and κ_{ref} is the reference curvature.

As to the tire model, a coupled slip Fiala tire model gives the longitudinal and lateral forces F_{xf,r} and F_{yf,r} respectively. The tire forces may be decomposed as:

$$[ \begin{matrix}{F}_{y} \\ {F}_{x}\end{matrix} ] = {F}_{total} [ \begin{matrix}\frac{- tan ( α )}{σ} \\ \frac{κ}{σ}\end{matrix} ] \qquad ( 5 )$$

where the tire slip angle and slip ratio are a and K, respectively, and the combined slip is σ. Fₜₒₜₐₗ is given as follows:

$${F}_{total} = \{ \begin{matrix}{C}_{f} σ - \frac{{C}_{f}^{2} {σ}^{2}}{3 μ {F}_{z}} + \frac{{C}_{f}^{3} {σ}^{3}}{27 {( μ {F}_{z} )}^{2}} & \vert σ \vert < {σ}_{si} \\ μ {F}_{z} & \vert σ \vert > {σ}_{si}\end{matrix} .$$

F_{z} is the normal load, C_{f} is the cornering stiffness, and μ is the coefficient of friction. Finally, the total slip at which the tire saturates, σₛₗ, and combined slip is represented by:

σₛₗ=arctan(3μF_{z}/C_{f}) (6)

σ=\sqrt{κ²+tan(α)²}. (7)

As to the NMPC, the NMPC is an algorithm used to manage complex systems where the relationship between inputs and outputs is non-linear. Unlike linear control methods, NMPC can handle a wide range of operating conditions and constraints by predicting future system behavior using a non-linear model. At each control step, NMPC solves an optimization problem to determine the optimal control actions that minimize a cost function while satisfying system constraints. The optimization problem for the NMPC may be given in the general form as:

$$\begin{matrix}min J & & \\ s . t . & {x}_{k + 1} = f ( {x}_{k} , {u}_{k} ) & ∀ k ∈ [ 1 , N ] \\ & g ( {x}_{k} , {u}_{k} ) = 0 & ∀ k ∈ [ 1 , N ] \\ & h ( {x}_{k} , {u}_{k} ) \leq 0 & ∀ k ∈ [ 1 , N ] \\ & {x}_{min} \leq {x}_{k} \leq {x}_{max} & ∀ k ∈ [ 1 , N ] \\ & {u}_{min} \leq {u}_{k} \leq {u}_{max} & ∀ k ∈ [ 1 , N ] \\ & {x}_{0} = {x}_{lookahead} & \end{matrix} \qquad ( 8 )$$

The state x is bounded by xₘᵢₙ and xₘₐₓ, the input u is bounded by uₘᵢₙ and uₘₐₓ, and the initial state x₀ is equal to x_{lookahead}, which is the current state integrated forward by the optimization runtime.

The cost function J is given as:

$$J = {J}_{{s}_{N}} + {\sum }_{i = 0}^{N - 1} ( {J}_{ref} + {J}_{stability} + {J}_{driver} ) \cdot {ds}_{i} \qquad ( 9 )$$

where dₛ is the distance traveled along the reference between steps.

To guide the vehicle 100 to the desired precomputed reference trajectory, the reference cost Jᵣₑf is given as:

J_{ref}=(x−x_{ref})Qₓ(x−x_{ref})^{T}+(\dot{x}−\dot{x}_{ref})Q_{\dot{x}}(\dot{x}−\dot{x}_{ref}) (10)

where x is the state vector of [e, Δφ, β, δ, ωᵣ] and \dot{x} is the state derivative vector of [\dot{r}, \dot{V}, \dot{β}, \dot{δ}, \dot{ω}ᵣ, \dot{τ}]. In all following instances, Q_{⋅} is a diagonal weight matrix.

The stability cost J_{stability} may act as a soft constraint. This is given as:

J_{stability}=αQ_{α}α+Q_{MPRP}J_{MPRP}+Q_{e,bound}J_{e,bound} (11)

which penalizes the slip angle α, violating track edges 14 and 16, and maintaining stability. J_{MPRP} keeps the vehicle in the unstable yet recoverable state space, while J_{e,bound} prevents the vehicle from violating track edges 14 and 16. Both costs are implemented via softplus functions to promote smoothness.

The terminal stability cost J_{sN} is a first-order restoring cost on the terminal sideslip and lateral error:

J_{sN}=Q_{\dot{β}}_{N}ds_{N}(\dot{β}_{N}+k_{\dot{β}}β_{ref,N})²+Q_{ė}ds_{N}(ė_{N}+k_{ė}e_{ref,N})². (12)

The driver tracking cost J_{driver} seeks to track the driver's intent over the first n steps:

J_{driver}=exp(−kn)(Q_{driver,δ}(δ−δ_{driver})²+Q_{driver,τ}(τ−τ_{driver})²)

The cost term is exponentially decayed in time over the first n=5 steps through exp(−kn), where k is the decay gain. Effectively, this decreases the effect of longer-term driver predictions as NMPC only applies the initial step, and driver predictions degrade over a longer horizon.

As to the solver implementation, the dynamics are converted to spatial terms as:

$$\frac{dx}{ds} = \frac{1}{\dot{s}} \frac{dx}{dt} = \frac{( 1 - {κ}_{ref} e )}{V cos Δ ϕ} \frac{dx}{dt} \qquad ( 14 )$$

where s is the path progress. Discretization occurs through a second-order implicit Runge Kutta method, and a variable horizon step length is used to achieve a long horizon with accurate short-term predictions. Specifically, the NMPC has a horizon of 20 points where the first discretization is ds=10 cm, followed by 7 points where ds=50 cm and 12 points of ds=1.5 m. Finally, the optimization problem is solved through an interior point optimizer.

Turning to task decomposition, the NMPC formulation can operate fully autonomously, assist the driver with both inputs or isolate individual actuators for the driver simply by adjusting the driver tracking weights and the inputs passed to the vehicle. For task decomposition, if the NMPC steers and the driver controls the throttle, Q_{driver}, is set to zero, and the driver throttle pedal input is passed through. When NMPC applies throttle, and the driver controls steering, Q_{driver,r} is set to zero, and the driver steering input is passed through.

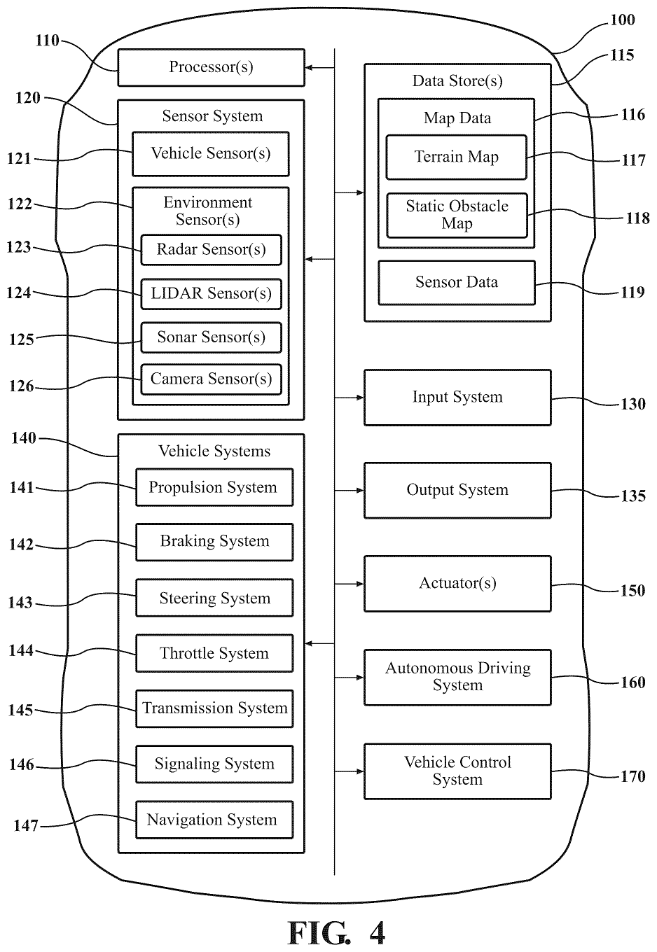

Now that the NMPC has been described, a brief description of the vehicle 100 will be given. Moreover, referring to FIG. 4, an example of a vehicle 100 is illustrated. As used herein, a “vehicle” is any form of powered transport. In one or more implementations, the vehicle 100 is an automobile. While arrangements will be described herein with respect to automobiles, it will be understood that embodiments are not limited to automobiles. In some implementations, the vehicle 100 may be any robotic device or form of powered transport that, for example, includes one or more automated or autonomous systems and thus benefits from the functionality discussed herein.

The automated/autonomous systems or combination of systems may vary in various embodiments. For example, in one aspect, the automated system is a system that provides autonomous control of the vehicle according to one or more levels of automation, such as the levels defined by the Society of Automotive Engineers (“SAE”) (e.g., levels 0-5). As such, the autonomous system may provide semi-autonomous control or fully autonomous control, as discussed in relation to the autonomous driving system 160.

The vehicle 100 also includes various elements. It will be understood that in various embodiments, it may not be necessary for the vehicle 100 to have all of the elements shown in FIG. 4. The vehicle 100 can have any combination of the various elements shown in FIG. 4. Further, the vehicle 100 can have additional elements to those shown in FIG. 4. In some arrangements, the vehicle 100 may be implemented without one or more of the elements shown in FIG. 4. While the various elements are shown as being located within the vehicle 100 in FIG. 4, it will be understood that one or more of these elements can be located external to the vehicle 100. Further, the elements shown may be physically separated by large distances and provided as remote services (e.g., cloud-computing services).

Some of the possible elements of the vehicle 100 are shown in FIG. 4 and will be described along with subsequent figures. However, a description of many of the elements in FIG. 4 will be provided after the discussion of the figures for purposes of brevity of this description. Additionally, it will be appreciated that for simplicity and clarity of illustration, where appropriate, reference numerals have been repeated among the different figures to indicate corresponding or analogous elements. In addition, the discussion outlines numerous specific details to provide a thorough understanding of the embodiments described herein. It should be understood that the embodiments described herein may be practiced using various combinations of these elements.

In either case, the vehicle 100 includes a vehicle control system 170. The vehicle control system 170 may be incorporated within an autonomous driving system 160 or may be separate, as shown. The vehicle control system 170 utilizes the NMPC and implements test decomposition so that a driver can more quickly learn a driving maneuver, such as drifting.

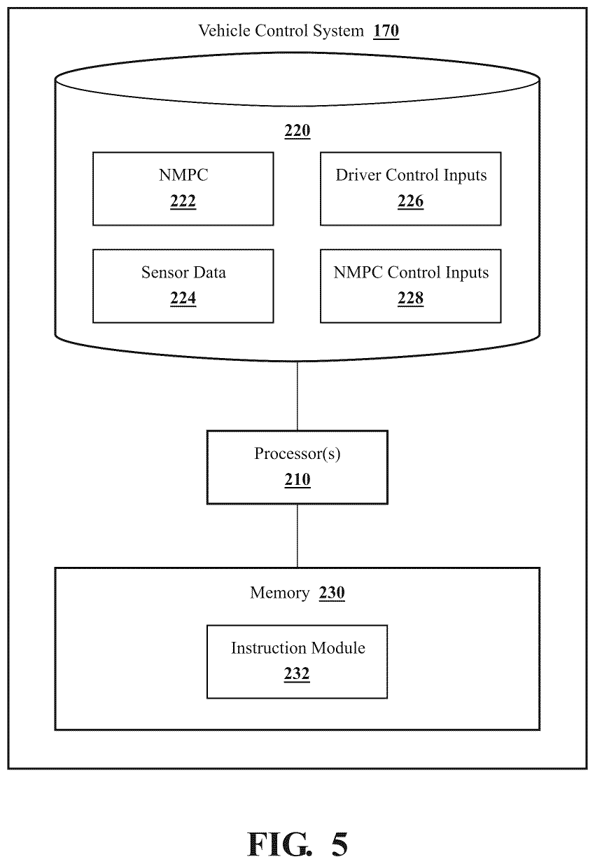

With reference to FIG. 5, one embodiment of the vehicle control system 170 is further illustrated. As shown, the vehicle control system 170 includes a processor(s) 210. Accordingly, the processor(s) 210 may be a part of the vehicle control system 170, or the vehicle control system 170 may access the processor(s) 210 through a data bus or another communication path. For example, the processor(s) 210 may be one or more processor(s) 110 found within the vehicle 100.

In one or more embodiments, the processor(s) 210 is an application-specific integrated circuit that is configured to implement functions associated with an instruction module 232. In general, the processor(s) 210 is an electronic processor, such as a microprocessor, capable of performing various functions described herein. In one embodiment, the vehicle control system 170 includes a memory 230 that stores the instruction module 232. The memory 230 is a random-access memory (“RAM”), read-only memory (“ROM”), a hard disk drive, flash memory, or other suitable memory for storing the instruction module 232. The instruction module 232 is, for example, computer-readable instructions that, when executed by the processor(s) 210, cause the processor(s) 210 to perform the various functions disclosed herein.

Furthermore, in one embodiment, the vehicle control system 170 includes data store(s) 220. The data store(s) 220 is, in one embodiment, an electronic data structure such as a database that is stored in the memory 230 or another memory and that is configured with routines that can be executed by the processor(s) 210 for analyzing stored data, providing stored data, organizing stored data, and so on. Thus, in one embodiment, the data store(s) 220 stores data used by the instruction module 232 in executing various functions.

In one embodiment, the data store(s) 220 includes the NMPC 222, which was previously described, sensor data 224 collected from the sensor system 120 of the vehicle, driver control inputs 226 that are generated by the driver when controlling one set of actuators, and NMPC control inputs 228 that may be generated by the NMPC 222 when controlling another set of actuators. As mentioned before, the driver control inputs 226 will differ from those of the NMPC control inputs 228, as the driver may only be allowed to control one set of actuators, such as actuator(s) 150 that control the steering system 143, while the NMPC 222 controls another set of actuator(s) 150 that control the throttle system 144 and vice versa.

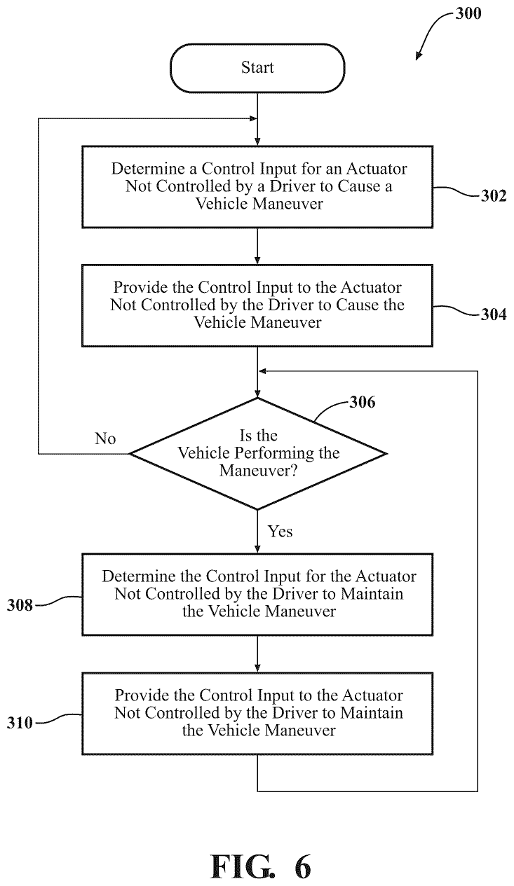

Accordingly, the instruction module 232 generally includes instructions that control the processor(s) 210 to perform any of the methodologies disclosed herein, such as the method 300 illustrated in FIG. 6. As such, the method 300 will be described from the viewpoint of the vehicle 100 of FIG. 4 and the vehicle control system 170 of FIG. 5. However, it should be understood that this is just one example of implementing the method 300. While method 300 is discussed in combination with the vehicle control system 170, it should be appreciated that the method 300 is not limited to being implemented within the vehicle control system 170, but is instead one example of a system that may implement the method 300.

In step 302, the instructions within the instruction module 232 cause the processor(s) 210 to determine the NMPC control inputs 228 for the actuator(s) 150 not controlled by the driver to cause the vehicle 100 to perform a particular vehicle maneuver, such as drifting. Moreover, the processor(s) 210 utilize the NMPC 222, which, in turn, utilizes the sensor data 224 and the driver control inputs 226 to determine the NMPC control inputs 228 for the actuator(s) 150 not controlled by the driver to cause the particular vehicle maneuver.

In step 304, the instructions within the instruction module 232 cause the processor(s) 210 to provide the NMPC control inputs 228 for the actuator(s) 150 not controlled by the driver to cause the vehicle 100 to perform a particular vehicle maneuver. Moreover, the NMPC control inputs 228 essentially take control of the actuator(s) 150. The NMPC 222 can isolate the actuator(s) 150 for the driver by adjusting the driver tracking. As such, during one training exercise, the NMPC control inputs 228 may be provided to the actuator(s) 150 that control the steering system 143, while, simultaneously, the driver has control of the throttle system 144 and/or the braking system 142. During another training exercise, the reverse may occur, wherein the NMPC control inputs 228 may be provided to the actuator(s) 150 that control the throttle system 144 and/or the braking system 142, while the driver has control of the steering system 143.

In step 304, the instructions within the instruction module 232 cause the processor(s) 210 to determine if the vehicle 100 is performing the maneuver. This may be achieved by utilizing the sensor data 224 generated by the sensor system 120. Moreover, the sensor data 224 may include information that can be used by the processor(s) 210 to determine if the vehicle 100 is performing the maneuver. If the vehicle 100 is not performing the maneuver, the method 300 returns to step 302; otherwise, the method 300 proceeds to step 308.

In step 308, the focus is on maintaining the vehicle maneuver. Some vehicle maneuvers, such as drifting, can be performed for lengthy periods, and therefore, once the maneuver is achieved, the focus of steps 308 and 310 is to maintain the performance of the maneuver. Moreover, in step 308, the instructions within the instruction module 232 cause the processor(s) 210 to determine the NMPC control inputs 228 for the actuator(s) 150 not controlled by the driver to maintain the performance of the vehicle maneuver. Moreover, the processor(s) 210 utilize the NMPC 222, which, in turn, utilizes the sensor data 224 and the driver control inputs 226 to determine the NMPC control inputs 228 for the actuator(s) 150 not controlled by the driver to maintain the particular vehicle maneuver.

In step 310, the instructions within the instruction module 232 cause the processor(s) 210 to provide the NMPC control inputs 228 for the actuator(s) 150 not controlled by the driver to cause the vehicle 100 to maintain a particular vehicle maneuver. As mentioned before, the NMPC control inputs 228 essentially maintain control of the actuator(s) 150 not controlled by the driver. After step 310, the method 300 may and/or may return to step 306.

It has been observed that implementing task decomposition, where the driver initially focuses on mastering one set of actuators (such as steering or throttle) while the NMPC 222 manages another set, leads to substantial improvements in retention tests. This method allows the driver to concentrate on a single aspect of vehicle control, reducing cognitive load and enhancing learning efficiency. As a result, drivers can achieve a higher level of proficiency more quickly. Furthermore, this approach has been shown to outperform a control group, demonstrating not only better immediate performance but also superior long-term retention of the skills acquired. The combination of focused practice and advanced control assistance provided by the NMPC 222 creates an optimal learning environment, leading to more effective and lasting skill development.

FIG. 4 will now be discussed in full detail as an example environment within which the system and methods disclosed herein may operate. In one or more embodiments, the vehicle 100 is an autonomous vehicle. As used herein, “autonomous vehicle” refers to a vehicle that operates in an autonomous mode. “Autonomous mode” refers to navigating and/or maneuvering the vehicle 100 along a travel route using one or more computing systems to control the vehicle 100 with minimal or no input from a human driver. In one or more embodiments, the vehicle 100 is highly automated or completely automated. In one embodiment, the vehicle 100 is configured with one or more semi-autonomous operational modes in which one or more computing systems perform a portion of the navigation and/or maneuvering of the vehicle 100 along a travel route, and a vehicle operator (i.e., driver) provides inputs to the vehicle to perform a portion of the navigation and/or maneuvering of the vehicle 100 along a travel route. Such semi-autonomous operation can include supervisory control as implemented by the vehicle control system 170 to ensure the vehicle 100 remains within defined state constraints.

The vehicle 100 can include one or more processor(s) 110. In one or more arrangements, the processor(s) 110 can be a main processor of the vehicle 100. For instance, the processor(s) 110 can be an electronic control unit (ECU). The vehicle 100 can include one or more data store(s) 115 for storing one or more types of data. The data store(s) 115 can include volatile and/or non-volatile memory. Examples of data store(s) 115 include RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The data store(s) 115 can be a component of the processor(s) 110, or the data store(s) 115 can be operatively connected to the processor(s) 110 for use thereby. The term “operatively connected,” as used throughout this description, can include direct or indirect connections, including connections without direct physical contact.

In one or more arrangements, the one or more data store(s) 115 can include map data 116. The map data 116 can include maps of one or more geographic areas. In some instances, the map data 116 can include information or data on roads, traffic control devices, road markings, structures, features, and/or landmarks in the one or more geographic areas. The map data 116 can be in any suitable form. In some instances, the map data 116 can include aerial views of an area. In some instances, the map data 116 can include ground views of an area, including 360-degree ground views. The map data 116 can include measurements, dimensions, distances, and/or information for one or more items included in the map data 116 and/or relative to other items included in the map data 116. The map data 116 can include a digital map with information about road geometry. The map data 116 can be high quality and/or highly detailed.

In one or more arrangements, the map data 116 can include one or more terrain map(s) 117. The terrain map(s) 117 can include information about the ground, terrain, roads, surfaces, and/or other features of one or more geographic areas. The terrain map(s) 117 can include elevation data in the one or more geographic areas. The map data 116 can be high quality and/or highly detailed. The terrain map(s) 117 can define one or more ground surfaces, which can include paved roads, unpaved roads, land, and other things that define a ground surface.

In one or more arrangements, the map data 116 can include one or more static obstacle map(s) 118. The static obstacle map(s) 118 can include information about one or more static obstacles located within one or more geographic areas. A “static obstacle” is a physical object whose position does not change or substantially change over a period of time and/or whose size does not change or substantially change over a period of time. Examples of static obstacles include trees, buildings, curbs, fences, railings, medians, utility poles, statues, monuments, signs, benches, furniture, mailboxes, large rocks, and hills. The static obstacles can be objects that extend above ground level. The one or more static obstacles included in the static obstacle map(s) 118 can have location data, size data, dimension data, material data, and/or other data associated with it. The static obstacle map(s) 118 can include measurements, dimensions, distances, and/or information for one or more static obstacles. The static obstacle map(s) 118 can be high quality and/or highly detailed. The static obstacle map(s) 118 can be updated to reflect changes within a mapped area.

The one or more data store(s) 115 can include sensor data 119. In this context, “sensor data” means any information about the sensors that the vehicle 100 is equipped with, including the capabilities and other information about such sensors. As will be explained below, the vehicle 100 can include the sensor system 120. The sensor data 119 can relate to one or more sensors of the sensor system 120. As an example, in one or more arrangements, the sensor data 119 can include information on one or more LIDAR sensors 124 of the sensor system 120.

In some instances, at least a portion of the map data 116 and/or the sensor data 119 can be located in one or more data store(s) 115 located onboard the vehicle 100. Alternatively, or in addition, at least a portion of the map data 116 and/or the sensor data 119 can be located in one or more data store(s) 115 that are located remotely from the vehicle 100.

As noted above, the vehicle 100 can include the sensor system 120. The sensor system 120 can include one or more sensors. “Sensor” means any device, component, and/or system that can detect and/or sense something. The one or more sensors can be configured to detect and/or sense in real-time. As used herein, the term “real-time” means a level of processing responsiveness that a user or system senses as sufficiently immediate for a particular process or determination to be made, or that enables the processor to keep up with some external process.

In arrangements in which the sensor system 120 includes a plurality of sensors, the sensors can work independently from each other. Alternatively, two or more of the sensors can work in combination with each other. In such a case, two or more sensors can form a sensor network. The sensor system 120 and/or one or more sensors can be operatively connected to the processor(s) 110, the data store(s) 115, and/or another element of the vehicle 100 (including any of the elements shown in FIG. 4). The sensor system 120 can acquire data of at least a portion of the external environment of the vehicle 100 (e.g., nearby vehicles).

The sensor system 120 can include any suitable type of sensor. Various examples of different types of sensors will be described herein. However, it will be understood that the embodiments are not limited to the particular sensors described. The sensor system 120 can include one or more vehicle sensor(s) 121. The vehicle sensor(s) 121 can detect, determine, and/or sense information about the vehicle 100 itself. In one or more arrangements, the vehicle sensor(s) 121 can be configured to detect and/or sense position and orientation changes of the vehicle 100, such as, for example, based on inertial acceleration. In one or more arrangements, the vehicle sensor(s) 121 can include one or more accelerometers, one or more gyroscopes, an inertial measurement unit (EIU), a dead-reckoning system, a global navigation satellite system (GNSS), a global positioning system (GPS), a navigation system 147, and/or other suitable sensors. The vehicle sensor(s) 121 can be configured to detect and/or sense one or more characteristics of the vehicle 100. In one or more arrangements, the vehicle sensor(s) 121 can include a speedometer to determine the current speed of the vehicle 100.

Alternatively, or in addition, the sensor system 120 can include one or more environment sensors 122 configured to acquire and/or sense driving environment data. “Driving environment data” includes data or information about the external environment in which an autonomous vehicle is located or one or more portions thereof. For example, one or more environment sensors 122 can be configured to detect, quantify, and/or sense obstacles in at least a portion of the external environment of the vehicle 100 and/or information/data about such obstacles. Such obstacles may be stationary objects and/or dynamic objects. The one or more environment sensors 122 can be configured to detect, measure, quantify, and/or sense other things in the external environment of the vehicle 100, such as lane markers, signs, traffic lights, traffic signs, lane lines, crosswalks, curbs proximate the vehicle 100, off-road objects, etc.

Various examples of sensors of the sensor system 120 will be described herein. The example sensors may be part of one or more environment sensors 122 and/or one or more vehicle sensor(s) 121. However, it will be understood that the embodiments are not limited to the particular sensors described.

As an example, in one or more arrangements, the sensor system 120 can include one or more radar sensors 123, one or more LIDAR sensors 124, one or more sonar sensors 125, and/or one or more cameras 126. In one or more arrangements, one or more cameras 126 can be high dynamic range (“HDR”) cameras or infrared (“IR”) cameras.

The vehicle 100 can include an input system 130. An “input system” includes any device, component, system, element, arrangement, or groups thereof that enable information/data to be entered into a machine. The input system 130 can receive input from a vehicle passenger (e.g., a driver or a passenger). The vehicle 100 can include an output system 135. An “output system” includes any device, component, arrangement, or groups thereof that enable information/data to be presented to a vehicle passenger (e.g., a person, a vehicle passenger, etc.).

The vehicle 100 can include one or more vehicle systems 140. Various examples of one or more vehicle systems 140 are shown in FIG. 4. However, vehicle 100 can include more, fewer, or different vehicle systems. It should be appreciated that although particular vehicle systems are separately defined, each or any of the systems or portions thereof may be otherwise combined or segregated via hardware and/or software within the vehicle 100. The vehicle 100 can include a propulsion system 141, a braking system 142, a steering system 143, a throttle system 144, a transmission system 145, a signaling system 146, and/or a navigation system 147. Each of these systems can include one or more devices, components, and/or a combination thereof, now known or later developed.

The navigation system 147 can include one or more devices, applications, and/or combinations thereof, now known or later developed, configured to determine the geographic location of the vehicle 100 and/or to determine a travel route for the vehicle 100. The navigation system 147 can include one or more mapping applications to determine a travel route for the vehicle 100. The navigation system 147 can include a global positioning system, a local positioning system, or a geolocation system.

The processor(s) 110, the vehicle control system 170, and/or the autonomous driving system 160 can be operatively connected to communicate with the vehicle systems 140 and/or individual components thereof. For example, returning to FIG. 4, the processor(s) 110 and/or the autonomous driving system 160 can be in communication to send and/or receive information from the vehicle systems 140 to control the movement, speed, maneuvering, heading, direction, etc. of the vehicle 100. The processor(s) 110, the vehicle control system 170, and/or the autonomous driving system 160 may control some or all of these vehicle systems 140 and, thus, may be partially or fully autonomous.

The processor(s) 110, the vehicle control system 170, and/or the autonomous driving system 160 can be operatively connected to communicate with the vehicle systems 140 and/or individual components thereof. For example, returning to FIG. 4, the processor(s) 110, the vehicle control system 170, and/or the autonomous driving system 160 can be in communication to send and/or receive information from the vehicle systems 140 to control the movement, speed, maneuvering, heading, direction, etc. of the vehicle 100. The processor(s) 110, the vehicle control system 170, and/or the autonomous driving system 160 may control some or all of these vehicle systems 140.

The processor(s) 110, the vehicle control system 170, and/or the autonomous driving system 160 may be operable to control the navigation and/or maneuvering of the vehicle 100 by controlling one or more of the vehicle systems 140 and/or components thereof. For instance, when operating in an autonomous mode, the processor(s) 110, the vehicle control system 170, and/or the autonomous driving system 160 can control the direction and/or speed of the vehicle 100. The processor(s) 110, the vehicle control system 170, and/or the autonomous driving system 160 can cause the vehicle 100 to accelerate (e.g., by increasing the supply of fuel provided to the engine), decelerate (e.g., by decreasing the supply of fuel to the engine and/or by applying brakes) and/or change direction (e.g., by turning the front two wheels). As used herein, “cause” or “causing” means to make, force, direct, command, instruct, and/or enable an event or action to occur or at least be in a state where such event or action may occur, either directly or indirectly.

The vehicle 100 can include one or more actuator(s) 150. The actuator(s) 150 can be any element or combination of elements operable to modify, adjust, and/or alter one or more of the vehicle systems 140 or components thereof to be responsive to receiving signals or other inputs from the processor(s) 110 and/or the autonomous driving system 160. Any suitable actuator can be used. For instance, one or more actuator(s) 150 can include motors, pneumatic actuators, hydraulic pistons, relays, solenoids, and/or piezoelectric actuators, to name a few possibilities.

The vehicle 100 can include one or more modules, at least some of which are described herein. The modules can be implemented as computer-readable program code that, when executed by a processor(s) 210, implements one or more of the various processes described herein. One or more of the modules can be a component of the processor(s) 110, or one or more of the modules can be executed on and/or distributed among other processing systems to which the processor(s) 110 is operatively connected. The modules can include instructions (e.g., program logic) executable by one or more processor(s) 110. Alternatively, or in addition, one or more data store(s) 115 may contain such instructions.

In one or more arrangements, one or more of the modules described herein can include artificial or computational intelligence elements, e.g., neural networks, fuzzy logic, or other machine learning algorithms. Further, in one or more arrangements, one or more of the modules can be distributed among a plurality of the modules described herein. In one or more arrangements, two or more of the modules described herein can be combined into a single module.

The vehicle 100 can include an autonomous driving system 160. The autonomous driving system 160 can be configured to receive data from the sensor system 120 and/or any other type of system capable of capturing information relating to the vehicle 100 and/or the external environment of the vehicle 100. In one or more arrangements, the autonomous driving system 160 can use such data to generate one or more driving scene models. The autonomous driving system 160 can determine the position and velocity of the vehicle 100. The autonomous driving system 160 can determine the location of obstacles, obstacles, or other environmental features, including traffic signs, trees, shrubs, neighboring vehicles, pedestrians, etc.

The autonomous driving system 160 can be configured to receive and/or determine location information for obstacles within the external environment of the vehicle 100 for use by the processor(s) 110 and/or one or more of the modules described herein to estimate position and orientation of the vehicle 100, vehicle position in global coordinates based on signals from a plurality of satellites, or any other data and/or signals that could be used to determine the current state of the vehicle 100 or determine the position of the vehicle 100 with respect to its environment for use in either creating a map or determining the position of the vehicle 100 in respect to map data.

The autonomous driving system 160, either independently or in combination with the vehicle control system 170 can be configured to determine travel path(s), current autonomous driving maneuvers for the vehicle 100, future autonomous driving maneuvers, and/or modifications to current autonomous driving maneuvers based on data acquired by the sensor system 120, driving scene models, and/or data from any other suitable source. “Driving maneuver” means one or more actions that affect the movement of a vehicle. Examples of driving maneuvers include accelerating, decelerating, braking, turning, moving in a lateral direction of the vehicle 100, changing travel lanes, merging into a travel lane, and/or reversing, to name a few possibilities. The autonomous driving system 160 can be configured to implement determined driving maneuvers. The autonomous driving system 160 can cause, directly or indirectly, such autonomous driving maneuvers to be implemented. As used herein, “cause” or “causing” means to make, command, instruct, and/or enable an event or action to occur or at least be in a state where such event or action may occur, either directly or indirectly. The autonomous driving system 160 can be configured to execute various vehicle functions and/or to transmit data to, receive data from, interact with, and/or control the vehicle 100 or one or more systems thereof (e.g., the vehicle systems 140).

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-6, but the embodiments are not limited to the illustrated structure or application.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components, and/or processes described above can be realized in hardware or a combination of hardware and software and can be realized in a centralized fashion in one processing system or in a distributed fashion where different elements are spread across several interconnected processing systems. Any processing system or another apparatus adapted for carrying out the methods described herein is suited. A typical combination of hardware and software can be a processing system with computer-usable program code that, when being loaded and executed, controls the processing system such that it carries out the methods described herein. The systems, components, and/or processes also can be embedded in computer-readable storage, such as a computer program product or other data programs storage device, readable by a machine, tangibly embodying a program of instructions executable by the machine to perform methods and processes described herein. These elements can also be embedded in an application product, which comprises all the features enabling the implementation of the methods described herein and which, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (“HDD”), a solid-state drive (“SSD”), a read-only memory (“ROM”), an erasable programmable read-only memory (“EPROM” or Flash memory), a portable compact disc read-only memory (“CD-ROM”), a digital versatile disc (“DVD”), an optical storage device, a magnetic storage device, or any suitable combination of the foregoing. In the context of this document, a computer-readable storage medium may be any tangible medium that can contain or store a program for use by or in connection with an instruction execution system, apparatus, or device.

Generally, module as used herein includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (“ASIC”), a hardware component of a system on a chip (“SoC”), as a programmable logic array (“PLA”), or as another suitable hardware component that is embedded with a defined configuration set (e.g., instructions) for performing the disclosed functions.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++, or the like, and conventional procedural programming languages, such as the “C” programming language or similar programming languages. The program code may execute entirely on the user's computer, partly on the user's computer, as a stand-alone software package, and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC, or ABC).

Aspects herein can be embodied in other forms without departing from the spirit or essential attributes thereof. Accordingly, reference should be made to the following claims rather than to the foregoing specification, as indicating the scope hereof.

1. A system mounted within a vehicle comprising a memory, the memory having instructions that, when executed by a processor, cause the processor to control a first actuator by a vehicle control system that uses a non-linear model predictive control to generate control inputs for the first actuator to achieve a drifting maneuver by the vehicle while a driver simultaneously provides driver inputs exclusively to a second actuator, wherein the driver inputs provided to the second actuator are passed through the vehicle without modification by the vehicle control system.

2. The system of claim 1, wherein the first actuator controls a lateral movement of the vehicle and the second actuator controls a longitudinal movement of the vehicle.

3. The system of claim 2, wherein the first actuator is a steering actuator that controls a steering system of the vehicle and the second actuator is a throttle actuator that controls the longitudinal movement of the vehicle.

4. (canceled)

5. The system of claim 1, wherein the first actuator is a throttle actuator that controls a longitudinal movement of the vehicle and the second actuator is a steering actuator that controls a steering system of the vehicle.

6. (canceled)

7. (canceled)

8. A method comprising controlling a first actuator by a vehicle control system mounted within a vehicle that uses a non-linear model predictive control to generate control inputs for the first actuator to achieve a drifting maneuver by the vehicle while a driver simultaneously provides driver inputs exclusively to a second actuator, wherein the driver inputs provided to the second actuator are passed through the vehicle without modification by the vehicle control system.

9. The method of claim 8, wherein the first actuator controls a lateral movement of the vehicle and the second actuator controls a longitudinal movement of the vehicle.

10. The method of claim 9, wherein the first actuator is a steering actuator that controls a steering system of the vehicle and the second actuator is a throttle actuator that controls a throttle system of the vehicle.

11. (canceled)

12. The method of claim 8, wherein the first actuator is a throttle actuator that controls a throttle system of the vehicle and the second actuator is a steering actuator that controls a steering system of the vehicle.

13. (canceled)

14. (canceled)

15. A non-transitory computer-readable medium having instructions that, when executed by a processor, cause the processor to control a first actuator by a vehicle control system mounted within a vehicle that uses a non-linear model predictive control to generate control inputs for the first actuator to achieve a drifting maneuver by the vehicle while a driver simultaneously provides driver inputs exclusively to a second actuator, wherein the driver inputs provided to the second actuator are passed through the vehicle without modification by the vehicle control system.

16. The non-transitory computer-readable medium of claim 15, wherein the first actuator controls a lateral movement of the vehicle and the second actuator controls a longitudinal movement of the vehicle.

17. The non-transitory computer-readable medium of claim 16, wherein the first actuator is a steering actuator that controls a steering system of the vehicle and the second actuator is a throttle actuator that controls a throttle system of the vehicle.

18. (canceled)

19. The non-transitory computer-readable medium of claim 15, wherein the first actuator is a throttle actuator that controls a throttle system of the vehicle and the second actuator is a steering actuator that controls a steering system of the vehicle.

20. (canceled)

21. The system of claim 1, wherein the vehicle control system uses the driver inputs to the second actuator to generate the control inputs for the first actuator.

22. The system of claim 21, wherein the non-linear model predictive control includes a cost function having a driver-tracking term based on the driver inputs to the second actuator.

23. The system of claim 1, wherein the vehicle control system is configured to switch, after a first period during which the vehicle control system controls the first actuator while the driver provides driver inputs exclusively to the second actuator, the driver inputs provided to the second actuator being passed through the vehicle without modification by the vehicle control system, to a second period during which the vehicle control system controls the second actuator while the driver provides driver inputs exclusively to the first actuator, the driver inputs provided to the first actuator being passed through the vehicle without modification by the vehicle control system.

24. The method of claim 8, wherein the vehicle control system uses the driver inputs to the second actuator to generate the control inputs for the first actuator.

25. The non-transitory computer-readable medium of claim 15, wherein the vehicle control system uses the driver inputs to the second actuator to generate the control inputs for the first actuator.
